(19) United States
(12) Patent Application Publication
(10) Pub. No.: US 2012/0247285 A1
(43) Pub. Date: Oct. 4, 2012

(54) UNIVERSAL BROKEN LIGHT BULB EXTRACTOR

(76) Inventor: Kristopher I. Eyre, Salt Lake City, UT (US)

(21) Appl. No.: 13/078,675

(22) Filed: Apr. 1, 2011

(51) Int. Cl. B25B 13/48

(52) U.S. Cl. 81/436

(57) ABSTRACT

A utility grip for extracting broken light bulb structures from all size sockets which can be either gripped with the hand or mounted on standard extension poles and handles for distance extractions. The utility grip engages the broken light bulb structure at whatever remaining structure is left and with a counterclockwise turn the structure to be loosened from the structure. The utility grip can accommodate light bulb sizes of 1.5v to 300v. In the specification, other uses are loosening threaded components such as bottle and container caps, funneling liquids and granulates into small and narrow-necked containers, and holding various household items.

### CROSS REFERENCE TO RELATED APPLICATIONS

Not Applicable

### FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

1. Field

The utility grip is invented to remove broken light bulb structures from various sized light bulb sockets. For references purposes, the device will be referred to a utility grip for word economy.

2. Prior Art

Because the removal of broken light bulb members from a light bulb socket has been a challenging problem over the years, many inventions have been designed to address the problem. For example, the following utility patents: U.S. Pat. No. 7,694,609 to Ma (2008); U.S. Pat. No. 6,976,407 to Desaulniers (2005); U.S. Pat. No. 6,928,901 to Rainin (2004); U.S. Pat. No. 6,260,442 to Bayat (2001); U.S. Pat. No. 3,797,055 to Greene (1972); and U.S. Pat. No. 1,319,028 to Grinnell (1919); and the following designs: Des. 400,768 to Mason (1997); Des. 364,323 to Zupo, et al (1994); and Des. 350,262 to Fallon (1993) teach various utilities and designs of light bulb extraction. Each teach the end(s) of the units can be inserted into a broken light bulb base for ease of extraction whether by hand and/or via a standard or custom designed pole. Although all have practical merit, the function of the patents do not factor in some or all of essential broken light bulb extraction elements, namely: the patents do not attempt to accommodate all sizes of light bulbs from the 1.5v to 300v incandescent light bulbs, the size or composition of the patents make it difficult to extract broken light bulbs in tight spots such as in common appliances such as refrigerators, microwaves, and other small and medium appliances, most of the patents require the use of a custom pole for distance extractions, the patents to not attempt to leverage the structure of the apparatus to provide other functions that have potential daily use, and most of the patents don't accommodate the ability to stick apparatus on most handles or poles of various sizes to provide distance extractions leveraging what is already around the house.

### General

Extracting a broken light bulb structure out of a light bulb socket is a tremendous challenge. When broken, the light bulb Because of the infrequency of breakage, consumers have not found it reasonable to invest in a dedicated broken bulb extractor forcing them to use pliers or something similar to the consistency of a potato to solve this challenging problem. The key to a successful broken light bulb extractor is to design the unit to make the structure viable for many other uses.

Broken light bulbs have different stages of breakage:
Stage 1—base separation from the main bulb structure to where the breakage leaves nothing but the base shell in the light socket;
Stage 2—base separation with some of the bulb glass base in the shell in the light socket;
Stage 3—the glass shell of light bulb is broken leaving the glass stem remaining whether partially or entirely intact; and
Stage 4—the glass shell is partially broken exposing extremely sharp edges. Remedies to each stage of breakage are not remedied by a single method.
   If breakages were limited to similarly sized bulbs and socket locations, the problem might not be so difficult. However, threaded light bulbs vary from the smallest 1.5v flashlight to the larger 300v light in older light fixtures and commercial uses.

Extracting light bulbs at each of these stages requires a device of various characteristics to ensure universal extraction, as follows:
Stage 1 Breakage—the bases of the various light bulbs range from ⅜″ to 1½″ and contact must be made around the edges of the base with a sufficient amount of co-efficient of friction to ensure that the base can be loosened for extraction.
Stage 2 Breakage—this type ofextraction is challenging due to the lack of structure to leverage for extraction. The utility grip to be considered must have a high coefficient of friction as well as flexibility in the grip to create as much surface area for maximum friction surface.
Stage 3 Breakage—tip of the light bulb glass stems range from 3/16″ to ¼″ in diameter with the standard glass structures widening from 5/16″ to ½″. The opening of the utility grip to be considered will need an opening to accommodate the glass stem diameter as well as leverage any glass structure elements to ease the loosening of the remaining light bulb structure
Stage 4 Breakage—the remains of the light bulb surface can cause more harm than any of the other stages breakage due to the sharp shards that remain. The utility grip must have the ability to grip the remains of the glass surface to minimize human contact and reduce further breakage that may cause harm to hands, eyes, or bare feet.

Given all the stages identified and the elements that need to be addressed for extraction, people try to solve the problems by using the following methods:
Stage 1—people have a couple of common remedies: 1) use a pair of pliers to either twist the base out gently or with force; and 2) use a potato or other similar materials to loosen the structure out;
Stage 2—people chip out a hole in the base and use methods described in Stage 1;
Stage 3—people use their hand or pliers to twist the remains of the glass stem; and
Stage 4—people use their hand to carefully loosen the remaining structure.
   Each of the methods above can be very dangerous because they are exposed to unsafe conditions, namely: electrocution, lacerations on the hands and feet, eye damage, and involving distance extractions, falling from a ladder. Also, botched extractions can be costly by damaging light sockets in lamps, chandeliers, and other light structures as well as light sockets in appliances and other smaller devices using threaded light bulbs.

To be effective, the utility grip needs to accommodate all size requirements, insulation from electrocution, provide distance extraction options, and provide a structure to ensure that the extraction is complete and successful regardless of what the remaining portions of the broken bulb are.

Due to the infrequency of broken light bulbs in the home, the utility grip needs to address other household challenges to make it viable.

### SUMMARY

Given the description above, the utility grip comprises of a uniform rubber medium to extract broken light bulb remnants.

### DRAWINGS

### Figures

The drawings are all labeled with closely related figures.

FIG. 1 shows a front, side view of the utility grip indicating showing the major contact points for the use of holding and contact with the broken light bulb components on the outside of the unit.

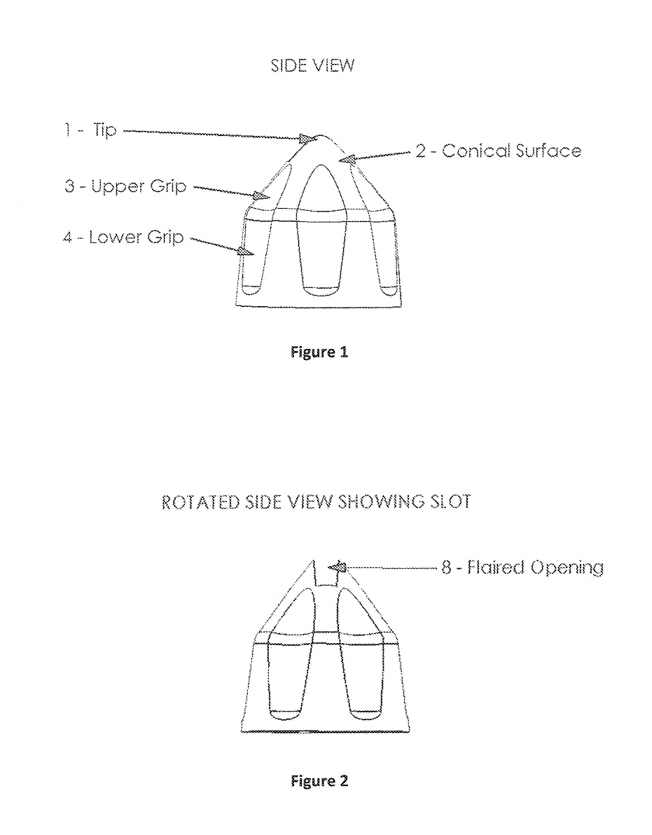

FIG. 2 shows a 90 degree rotated view of the utility grip from another side perspective indicating the opening of the unit with a flaired opening.

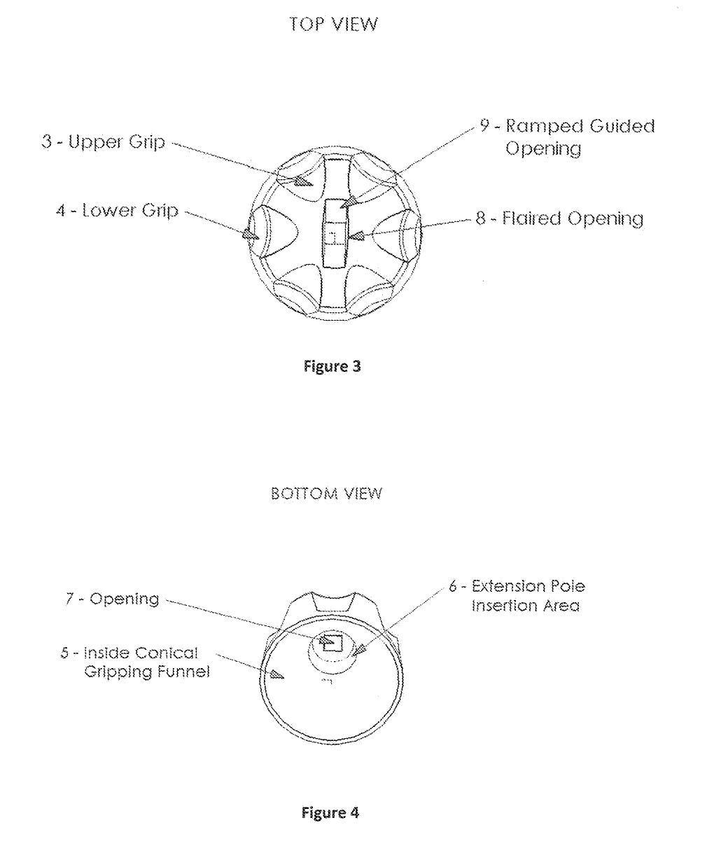

FIG. 3 shows the top view of the utility grip featuring the ramped guided opening.

FIG. 4 shows the bottom view of the utility grip with two primary sections: extension pole insertion area and inside conical gripping funnel.

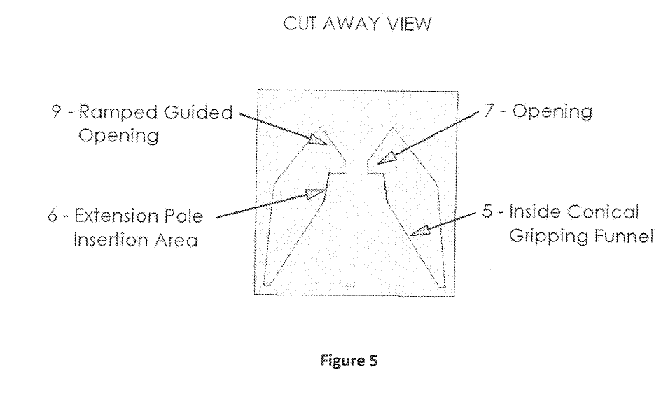

FIG. 5 shows a cutaway view of the unit exposing the internal structure of the unit.

### REFERENCE NUMERALS

1—Tip

2—Conical Surface

3—Upper Grip

4—Lower Grip

5—Inside Conical Gripping Funnel

6—Extension Pole Insertion Area

7—Opening

8—Flaired Opening

9—Ramped Guided Opening

### DETAILED DESCRIPTION

### FIG. 1—First Embodiment

The embodiment of the unit is illustrated in FIGS. 1, 3, and 4. FIG. 1 shows that the overall unit is shaped in a conical form to provide functionality in two major sections: surface engagement and grip. The surface engagement section comprising of 1—Tip and 2—Conical Surface to allow safe engagement with the broken structure of the light bulb. The unit is made of a tacky, rubbery material is readily available from many suppliers. The right substance can be found at the following suppliers: GLS Corporation of Cary, Ill.; Elastocon of Rochester, Ill. In order for this product to work effectively, the material needs to be a rubbery consistency with a lower durameter to provide a tacky surface. The 3—Upper Grip and 4—Lower Grip are both used to provide a soft, durable gripping surface for broken light bulb extraction on the tip side of the unit and loosening any threaded caps with the upper and lower grip structure.

FIG. 3 illustrates the combined features of a flaired opening and guiding ramp opening to allow for easy entry of the glass stem into the unit. The flaired opening is so that the glass stem can enter without interference from the tip. The ramped guided opening provides a pathway for the glass stem to be centered in the unit to prevent further breakage during the extraction process.

FIG. 4 illustrates the capability of the unit to be securely mounted on an extension pole through the small opening and for the consumer to use the tacky 5—Inside Conical Gripping Funnel for loosening container tops and caps. The TPE material is food grade enabling the 5—Inside Conical Gripping Funnel to act as a funnel for liquids and granular mediums (salt, pepper, various herbs).

FIG. 2 illustrates the variable access for the connection with the broken structure of the light bulb through the 8—Flaired Opening. The ridges of the unit provide a way to engage with the sharp broken structure of the broken light bulb reducing the likelihood of injury.

FIG. 5 illustrates the internal structure of the unit showing the 7—Opening, 9—Ramped Guided Opening, 6—Extension Pole Insertion Area, and 5—Inside Conical Gripping Funnel. The unit tapers down to a small edge to ensure that the base is flexible to maneuver over variable sizes of tops and caps. Due to the tackiness of the material, the unit grips any surface allowing the ability to extract hot incandescent light bulbs.

### Advantages

From the description above, a number of advantages of some embodiments of the utility grip become evident:

(a) The utility grip provides an economical, affordable solution made out of readily available rubbery materials.

(b) The utility grip provides greater capabilities such as gripping hot light bulbs for replacement.

(c) The utility grip loosens bottle, container, medication caps leveraging the tacky surface of the gripping unit.

(d) The utility grip is formed in the shape of a funnel for pouring liquids and granulates into small and narrow-necked containers.

(e) The utility grip extracts all sizes of incandescent light bulbs from 1.5v to 300v bulbs.

(f) The utility grip enables removal of broken light bulbs in very tight, hard to reach locations due to its structure.

(g) The utility grip structure allows it to be mounted on common pole ends such as a broom stick.

(h) The utility grip can be used to hold various items such as pens, pencils, and other items.

### Conclusion, Ramifications, and Scope

Accordingly, the reader will see that the utility grip in its various embodiments can be used to replace broken incandescent light bulbs of all sizes, can be used to extract broken light bulbs from a distance leveraging its funnel structure for standard extension poles and other commonly used handles, can be used to loosen bottle, container, and medication caps, can be used using its funnel shape to pour liquids and granulates into small and narrow-necked containers.

Although the description above contains many specificities, these should not be construed as limiting the scope of the embodiments but as merely providing illustrations of some of the presently preferred embodiments.

Thus, the scope of the embodiments should be determined by the appended claims and their legal equivalents rather than by the examples given.

I claim:

1. A utility grip that removes broken light bulb structures comprising:
a. a notched tip that flairs slightly outward, and
b. a ramped opening into a hole in the middle of the utility grip, and
c. a funnel opening at the base, and
d. a tacky rubbery material with a significant coefficient of friction.

2. The utility grip in claim 1 that removes broken light bulb structures from a distance using available handles and poles comprising:
a. an angled funnel with the tacky, rubbery material, and
b. a steeper angled section in the funnel that provides a tight fit for standard extension pole ends.

3. The utility grip in claim 1 that loosens bottle, container, medication, and canister caps comprising:
a. an angled funnel at the base with the tacky, rubbery material with a high coefficient of friction.

4. The utility grip in claim 1 that funnels liquids and granulates into small and narrow-necked containers comprising:
a. an angled funnel at the base;
b. the opening at the top of the apparatus; and
c. the conical surface at the top of the apparatus.
